(19) United States
(12) Patent Application Publication
(10) Pub. No.: US 2007/0239593 A1
(43) Pub. Date: Oct. 11, 2007

(54) Collective purchase model for medical products

(76) Inventors: Michael J. Sweeney, Jacksonville, FL (US); John M. McGuire, Jacksonville, FL (US)

Correspondence Address: TAFT, STETTINIUS & HOLLISTER LLP, SUITE 1800, 425 WALNUT STREET, CINCINNATI, OH, 45202-3957, US

(21) Appl. No.: 11/732,699

(22) Filed: Apr. 4, 2007

Related U.S. Application Data
(63) Continuation-in-part of application No. 11/048,110, filed on Feb. 1, 2005.

(51) Int. Cl. G06Q 40/00

(52) U.S. Cl. 705/37

(57) ABSTRACT

It is a first aspect of the present invention to provide a method of procuring medical components and/or services that includes the steps of: (a) forming a consortium, the consortium having members including at least physician owners and hospital members; (b) evaluating by the consortium a first plurality of manufacturers of products in a relevant product category; (c) determining by the consortium a second plurality of the manufacturers as being clinically acceptable, the determining step being based on the results of the evaluating step; (d) soliciting bids by the consortium from each of the clinically acceptable manufacturers; (e) selecting by the consortium at least one of the clinically acceptable manufacturers to be a preferred supplier of products in the relevant product category; and (f) forming a supplier agreement with each supplier selected in step (e) pursuant to the bid submitted by that supplier.

### CROSS-REFERENCE

This application is a continuation-in-part of U.S. application Ser. No. 11/048,110, filed Feb. 1, 2005, which is incorporated herein by reference in its entirety.

### BACKGROUND OF THE INVENTION

This invention relates to a procurement method for the collective purchase of products, particularly medical products such as cardiology implant devices, for use by members of a consortium.

The prior art contains interactive models that allow medical staff members to access information regarding products and receive price quotes from vendors of the products. The prior art also contains interactive models that allow medical staff members to purchase products by auction over a computer-implemented network. Additionally, the prior art describes a system that facilitates the selection and ordering of products by medical staff members through an administrative agent. These prior art methods, however, do not provide a step for review of available products and designation of preferred products by an advisory panel, nor do they align financial incentives of physicians and hospitals. Additionally, these prior art methods do not pool the buying power of physicians from different practice groups.

The present invention addresses these deficiencies in the prior art by providing for the collective purchase of products by hospitals who are members of a buying consortium, and by providing a step for a physician advisory panel of the buying consortium to review available products and designate preferred products.

### SUMMARY

The present invention is generally directed to a method for the collective purchase of medical components and/or services for use by members of a consortium. The consortium can evaluate the various product offerings in a relevant product category and select one or more specific products or manufacturers to be used as preferred suppliers of that product to the consortium's members. This procurement method allows the physician owners and the hospital members of the consortium to pool their buying power to receive favorable pricing for participating hospitals and to ensure that the products used by the consortium's members meet the consortium's standards for quality.

It is a first aspect of the present invention to provide a method of procuring medical components and/or services that includes the steps of: (a) forming a consortium, the consortium having members including at least physician owners and hospital members; (b) evaluating by the consortium a first plurality of manufacturers of medical products in a relevant medical product category; (c) determining by the consortium a second plurality of the manufacturers from the first plurality of manufacturers as being clinically acceptable, the determining step being based on the results of the evaluating step; (d) soliciting bids by the consortium from each of the clinically acceptable manufacturers; (e) selecting by the consortium at least one of the clinically acceptable manufacturers to be a preferred supplier of products in the relevant product category; and (f) forming a supplier agreement with each supplier selected in step (e) pursuant to the bid submitted by that supplier. In one embodiment, the first plurality of manufacturers includes substantially every manufacturer of products in the relevant product category. In another embodiment, the second plurality of manufacturers is fewer in number than the first plurality of manufacturers.

In another embodiment of this aspect, an additional step (g) purchasing medical products in the relevant medical product category from a preferred supplier for that product category is included. In some embodiments, the purchasing step (g) is repeated each time the products in the relevant product category are needed. In other embodiments, steps (a) through (g) are repeated at the discretion of the members of the consortium. In another embodiment, step (f) is performed by the contracting agent on behalf of the consortium.

In yet another embodiment, the relevant medical product category is a category of products used in the practice of medicine. In other embodiments, the relevant product category is cardiology-related products.

In one embodiment of the invention, the evaluating step (b) and the determining step (c) are performed by members of an advisory panel of the consortium. The members of the advisory panel may be physicians such as cardiologists. In some embodiments, the purchasing step (g) is performed by a hospital with which a member of the consortium has contracted. In such an embodiment, the consortium receives an administrative fee from the preferred supplier for each purchase order pursuant to the supplier agreement.

From the foregoing disclosure and the following detailed description of various preferred embodiments it will be apparent to those skilled in the art that the present invention provides a significant advance in the art of purchase models for medical products. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawing in which:

FIG. 1 is a flow diagram of one embodiment of the present invention.

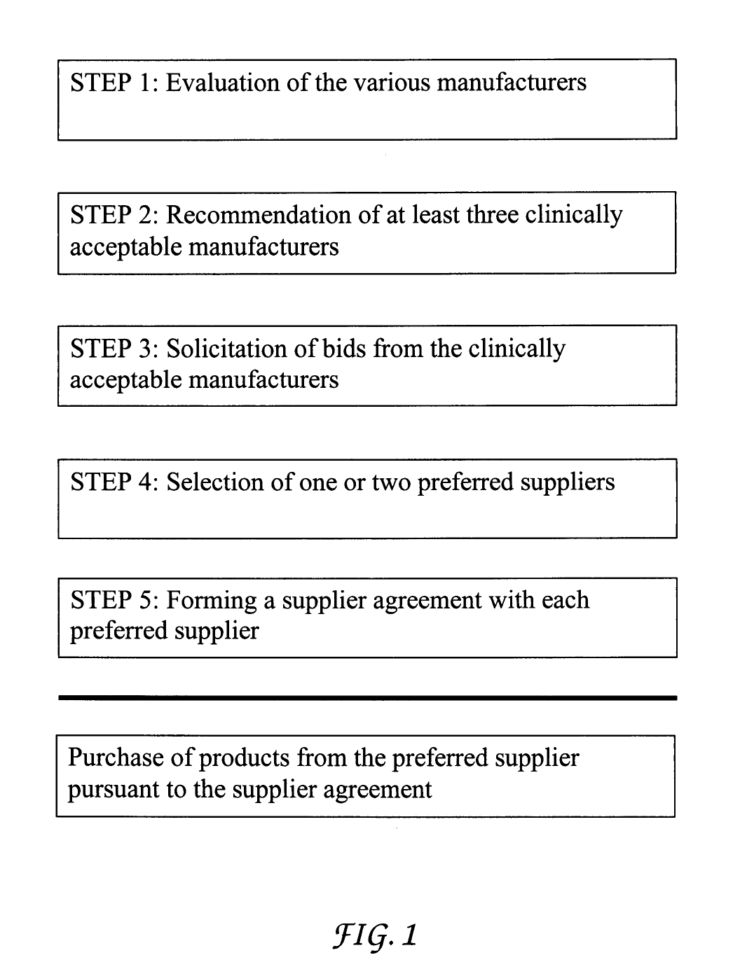

### DETAILED DESCRIPTION

It will be apparent to those skilled in the art that many uses and variations are possible for the collective purchase model for medical products. The following detailed discussion of various alternative and preferred embodiments will illustrate the general principles of the invention. Other embodiments will be apparent to those skilled in the art given the benefit of this disclosure.

The present invention is generally directed to a method for the collective purchase of medical components and/or services by members of a consortium (hereinafter referred to as the “Consortium”). The Consortium can evaluate the various product offerings in a relevant product category and select one or more specific products or manufacturers to be used as preferred suppliers of that product to the Consortium's members. This procurement method, which is described in detail in the following paragraphs, allows the members of the Consortium to pool their buying power to receive favorable pricing and to ensure that the products used by the Consortium's members meet the Consortium's standards for quality.

In an exemplary embodiment, this invention can be practiced as a purchasing model used by a cardiology consortium to arrange for the sale of surgical implants and other cardiology-related products to participating hospitals. The Consortium is a separate business entity, a limited liability company, whose members and minority owners are cardiologists who may own their membership interests through separate local limited liability companies. The majority owner of the Consortium is a separate entity owned by non-physicians, retired physicians, and physicians who do not practice in any area served by the Consortium. The manager of the Consortium is another entity (hereinafter referred to as the “Agent”) that will conduct the negotiations and contract with suppliers on behalf of the Consortium. The manager has no ownership interest in the Consortium. The objective of the Consortium is to pool the buying power of its physician owners and member hospitals, collectively negotiating with suppliers of the surgical implants and other cardiology-related products to obtain favorable prices on these items. The resulting alignment of incentives between hospitals and the cardiologists will provide hospital systems with competitive, predictable pricing at levels that are not attainable in the other business models.

For each product category (e.g., pacemakers), the Consortium selects one or two preferred suppliers according to the following detailed embodiment. First, the Consortium has an advisory panel (composed of physician owners, who can be elected to serve on the advisory panel on a rotational basis and be compensated for such service) that evaluates the various manufacturers of products in the relevant product category. Based on this evaluation, the advisory panel recommends at least three clinically acceptable manufacturers for use by member physicians. Next, the Consortium (through the Agent) solicits bids from these competing manufacturers. Finally, one or two of the manufacturers submitting the bids will be selected as preferred suppliers for the product category. This selection of the preferred suppliers can be based upon bid price, product quality, level of service, or other factors deemed relevant by the advisory panel. These preferred suppliers will then be used to supply products in that product category (e.g., pacemakers) to participating hospitals for use by Consortium physician owners. Although the preferred suppliers will be the suppliers of choice for the physician owners to use for products in the relevant product category, physician owners and participating hospitals retain the freedom to choose a product from another supplier if such product is deemed more appropriate for a particular patient.

The advisory panel will periodically review the performance (including quality of the products themselves and the service provided by the supplier) of the preferred suppliers in each product category, with the possibility of conducting a new selection of preferred suppliers for a product category if the current suppliers are determined to be unsatisfactory. Additionally, the preferred suppliers can be designated for a fixed contract term (three years in an exemplary embodiment), and the advisory panel can choose to extend such preferred supplier contracts for an additional fixed term at its discretion.

With this method, the incentives of physicians and hospitals are aligned by the pooling of their buying power, and this market consolidation will enable suppliers who are selected by the Consortium to enjoy a substantial increase in their sales. As cardiology implant procedures are now performed in most hospital settings, there is extreme fragmentation of the market with the resultant loss of negotiation leverage by the purchaser (i.e., the hospital). The goal of the Consortium, through the actions of its physician owners and participating member hospitals, is to offer its limited number of suppliers the opportunity to access a large volume of cases over the life of an extended contract, with the potential that such suppliers could substantially increase their sales. Hospitals should be able to obtain very favorable pricing on cardiology products through the concentration of their market share over a small number of suppliers in each product category.

When a physician at a participating member hospital needs to use a product in a product category that is handled by the Consortium, the hospital will purchase the product from one of the preferred suppliers for that product category, at the price and terms negotiated by the Consortium for that particular product. For each sale, the preferred supplier will pay an administrative fee to the Consortium pursuant to the contract negotiated between the preferred supplier and the Consortium.

As mentioned above, the Agent will conduct the negotiations and contract with suppliers on behalf of the Consortium. The Agent can provide contract negotiation and implementation, financial and operational management, advisory panel support services, organization and strategic planning, and all other duties and responsibilities of the Consortium. Also, the Agent, as the manager of the Consortium, can take the lead in creating the Consortium. The Agent has the sole authority to enter into binding agreements on behalf of the Consortium. Physician owners (who are cardiologists in the exemplary embodiment described herein) make an initial financial commitment to purchase their individual ownership interest in the Consortium. Each potential physician owner, as an accredited investor, will be eligible to purchase one unit in the Consortium via a local limited liability company. While this investment entitles each physician owner to share in any and all proceeds from the Consortium, no terms of a owner's investment and ownership, including return on investment, shall be directly proportional to such owner's device implant case volumes. The return on investment for any owner shall be directly proportion to such owner's percentage ownership interest in the consortium. In addition, there is no obligation of owners to restrict their (or their physician shareholders' or members') implant selection to specific vendors or manufacturers.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A method of procuring medical components and/or services, comprising the steps of:
(a) forming a consortium, the consortium having members including at least physician owners and hospital members;
(b) evaluating by the consortium a first plurality of manufacturers of medical products in a relevant medical product category;
(c) determining by the consortium a second plurality of the manufacturers as being clinically acceptable from the first plurality of manufacturers, the determining step being based on the results of the evaluating step;
(d) soliciting bids by the consortium from each of the clinically acceptable manufacturers;
(e) selecting by the consortium at least one of the clinically acceptable manufacturers to be a preferred supplier of products in the relevant product category; and
(f) forming a supplier agreement with each supplier selected in step (e) pursuant to the bid submitted by that supplier.

2. The method of claim 1, wherein a contracting agent is the manager of the consortium; and wherein step (f) is performed by the contracting agent on behalf of the consortium.

3. The method of claim 2, wherein the relevant medical product category is a category of products used in the practice of medicine.

4. The method of claim 2, wherein the relevant medical product category is cardiology-related products.

5. The method of claim 2, wherein the evaluating and determining steps are performed by members of an advisory panel of the consortium.

6. The method of claim 2, wherein the members of the advisory panel are physicians.

7. The method of claim 2, wherein the members of the advisory panel are cardiologists.

8. The method of claim 2, further comprising the step of:
(g) purchasing products in the relevant product category from a preferred supplier for that product category.

9. The method of claim 2, wherein the first plurality of manufacturers includes substantially every manufacturer of products in the relevant product category.

10. The method of claim 2, wherein the second plurality of manufacturers is fewer in number than the first plurality of manufacturers.

11. The method of claim 8, wherein the purchasing step (g) is performed by a hospital with which a member of the consortium has contracted; and wherein the consortium receives an administrative fee from the preferred supplier for each purchase order pursuant to the supplier agreement.

12. The method of claim 8, further comprising the step of:
repeating the purchasing step (g) each time the products in the relevant product category are needed.

13. The method of claim 8, further comprising the step of:
repeating steps (a) through (g) at the discretion of the members of the consortium.

14. The method of claim 1, wherein the forming step (a) further includes the step of purchasing, by the members, units of ownership into the membership.
